(19) United States
(12) Patent Application Publication
(10) Pub. No.: US 2026/0149125 A1
(43) Pub. Date: May 28, 2026

(54) BATTERY MODULE AND METHOD OF MANUFACTURING THE SAME

(71) Applicant: TOYOTA JIDOSHA KABUSHIKI KAISHA, Toyota-shi (JP)

(72) Inventor: Takenori IKEDA, Owariasahi-shi (JP)

(73) Assignee: TOYOTA JIDOSHA KABUSHIKI KAISHA, Toyota-shi (JP)

(21) Appl. No.: 19/323,298

(22) Filed: Sep. 9, 2025

(30) Foreign Application Priority Data
Oct. 31, 2024 (JP) 2024-191857

(51) Int. Cl. H01M 50/46; H01M 4/02; H01M 4/70; H01M 50/463

(52) U.S. Cl. CPC H01M 50/46; H01M 4/70; H01M 50/463; H01M 2004/029

(57) ABSTRACT

A battery module includes a plurality of electrode sheets, a plurality of separators stacked alternately with the electrode sheets, and an electrolyte sealed between the electrode sheets, in which a through-hole penetrating through the electrode sheets and the separators is provided, and the through-hole communicates with an outside and is isolated from a space in which the electrolyte is sealed.

### CROSS-REFERENCE TO RELATED APPLICATION

This application claims priority to Japanese Patent Application No. 2024-191857 filed on Oct. 31, 2024. The disclosure of the above-identified application, including the specification, drawings, and claims, is incorporated by reference herein in its entirety.

### BACKGROUND

### 1. Technical Field

The present specification relates to a battery module in which a plurality of electrode sheets is stacked.

### 2. Description of Related Art

Japanese Unexamined Patent Application Publication No. 2021-034351 (JP 2021-034351 A) discloses a battery module in which a plurality of electrode sheets is stacked. A heat-dissipating member is disposed between two battery modules.

### SUMMARY

In the technique of JP 2021-034351 A, heat of the battery module is transmitted from a surface in contact with the heat-dissipating member to the heat-dissipating member. Whereas heat dissipation of an electrode sheet in contact with the heat-dissipating member is facilitated, heat dissipation of an electrode sheet not in contact with the heat-dissipating member is impeded. Heat dissipation rates vary among the respective electrode sheets. The present specification provides a technique for cooling a plurality of electrode sheets at the same time.

A battery module disclosed in the present specification includes
a plurality of electrode sheets,
a plurality of separators alternately stacked with the electrode sheets, and
an electrolyte sealed between the electrode sheets, in which
a through-hole penetrating the electrode sheets and the separators is provided, and
the through-hole communicates with the outside and is isolated from a space in which the electrolyte is sealed.

With the above configuration, it is possible to cool each of the stacked electrode sheets at the same time by passing a refrigerant through the through-holes.

Details of the technique and further improvements disclosed in the present specification will be described in “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery module;

FIG. 2 is an enlarged plan view of a range II shown in FIG. 1;

FIG. 3 is a cross-sectional view taken along line III-III shown in FIG. 2;

FIG. 4 is a diagram showing one step of manufacturing the battery module; and

FIG. 5 is a diagram showing another step of manufacturing the battery module.

### DETAILED DESCRIPTION OF EMBODIMENTS

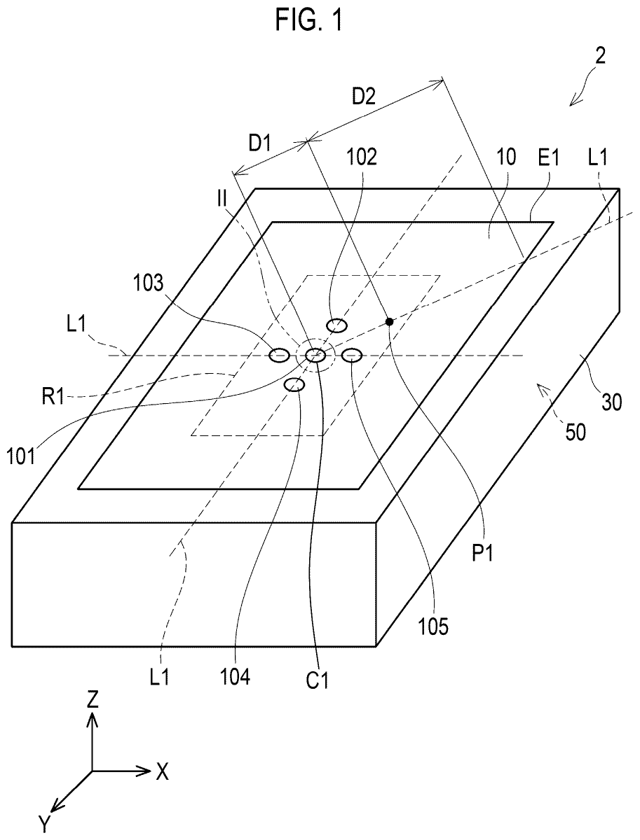

### Configuration of Battery Module 2 (see FIGS. 1 to 3)

The battery module 2 includes a plurality of stacked electrode sheets 10 and an outer frame 30 covering the periphery of the electrode sheets 10. The electrolyte 50 is injected between the electrode sheets 10, and the outer frame 30 seals the electrolyte 50 between the electrode sheets 10. In one example, the battery module 2 is a module for a lithium ion battery. An XYZ coordinate system is defined in the figure. The Z-axis direction corresponds to a stacking direction in which the electrode sheets 10 are stacked.

A plurality of through-holes 101 to 105 penetrating through the electrode sheets 10 along the stacking direction is provided in the electrode sheets 10. The through-holes 101 to 105 are located in the central region R1 of the battery module 2 when the battery module 2 is viewed along the stacking direction. The central region R1 is a set of points P1 at which the distance D1 to the center C1 is shorter than the distance D2 to the outer edge E1, on any straight line L1 that extends radially from the center C1 of the battery module 2 toward the outer edge E1 of the electrode sheet 10. The through-hole 101 is located at the center C1 in the central region R1. The through-holes 102, 104 are located on the straight line L1 extending along the Y-axis direction in the central region R1. The through-holes 103, 105 are located on the straight line L1 extending along the X-axis direction in the central region R1. The positions of the through-holes 101 to 105 in FIG. 1 are merely examples. In addition, the number of the through-holes is not limited to five, and may be four or less, or six or more.

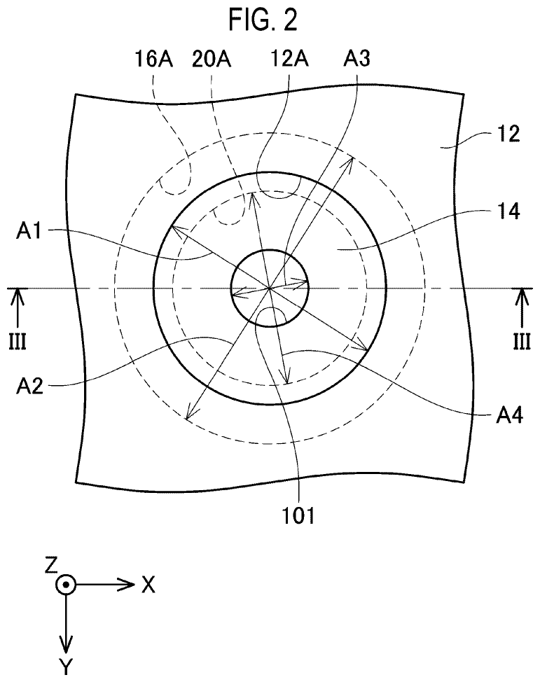

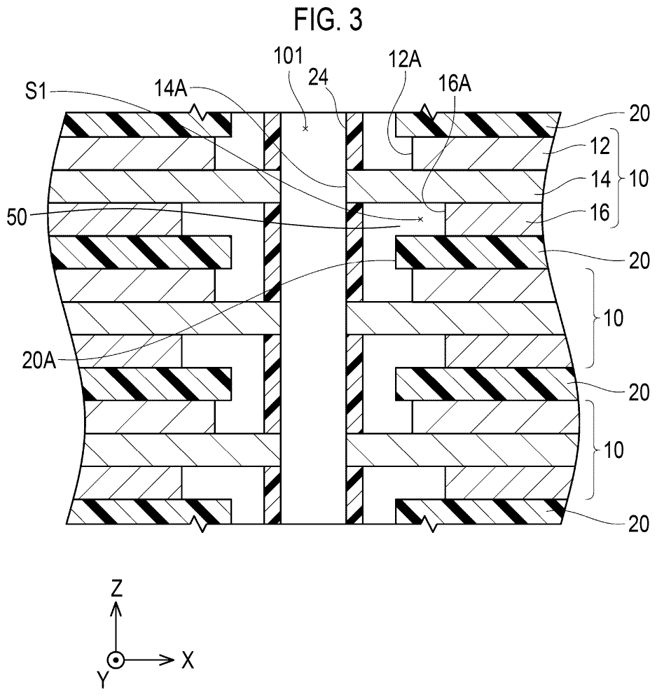

FIG. 2 is an enlarged plan view of the vicinity of the through-hole 101. FIG. 3 is a cross-sectional view of the vicinity of the through-hole 101. As shown in FIG. 3, the battery module 2 includes the electrode sheets 10 and a plurality of separators 20 stacked alternately with the electrode sheets 10. The electrode sheets 10 and the separators 20 constitute a plurality of secondary battery cells connected in series.

In FIG. 3, a cross-section of the bipolar electrode sheet 10 among the electrode sheets 10 is shown. The bipolar electrode sheet 10 is configured by stacking a negative electrode film 12 containing a negative electrode active material, a current collector foil 14, and a positive electrode film 16 containing a positive electrode active material. The negative electrode film 12 is provided on a first surface of the current collector foil 14, and the positive electrode film 16 is provided on a second surface of the current collector foil 14. The current collector foil 14 may be, for example, a stacked body of an aluminum foil and a copper foil. Various positive electrode active materials and negative electrode active materials for a lithium ion battery can be appropriately adopted as the positive electrode active material and the negative electrode active material.

Although not shown in FIG. 3, the electrode sheets 10 include unipolar positive electrode and negative electrode sheets 10. The unipolar positive electrode sheet 10 is constituted of the positive electrode film 16 and the current collector foil 14 such as a copper foil, and the unipolar negative electrode sheet 10 is constituted of the negative electrode film 12 and the current collector foil 14 such as an aluminum foil. The unipolar positive electrode sheet 10 is stacked at a first end of the stacking direction of the plurality of bipolar electrode sheets 10, and the unipolar negative electrode sheet 10 is stacked at a second end of the stacking direction of the bipolar electrode sheets 10.

As shown in FIG. 3, the through-hole 101 penetrates through the electrode sheets 10 and the separators 20. The through-hole 101 passes through an opening 12A provided in the negative electrode film 12, an opening 14A provided in the current collector foil 14, an opening 16A provided in the positive electrode film 16, and an opening 20A provided in the separator 20. The openings 14A provided in the current collector foils 14 are connected to each other by the adhesive layer 24 extending along the stacking direction. The adhesive layer 24 is formed of, for example, a thermosetting resin. The adhesive layer 24 isolates the through-hole 101 from the space S1 that is between two adjacent electrode sheets 10 and in which the electrolyte 50 is sealed.

As shown in FIG. 2, the openings 12A, 14A, 16A, 20A are circular. The diameter A1 of the opening 12A of the negative electrode film 12 and the diameter A2 of the opening 16A of the positive electrode film 16 are larger than the diameter A3 of the opening 14A of the current collector foil 14. In addition, the diameter A1 of the opening 12A of the negative electrode film 12 is smaller than the diameter A2 of the opening 16A of the positive electrode film 16. In addition, the diameter A4 of the opening 20A of the separator 20 is smaller than the diameters A1, A2, and is larger than the diameter A3. The shape of the openings 12A, 14A, 16A, 20A may be a shape other than a circular shape, such as an ellipse, an oval, or a polygon. In any case, the opening 12A of the negative electrode film 12 and the opening 16A of the positive electrode film 16 may be larger than the opening 14A of the current collector foil 14. In addition, the opening 12A of the negative electrode film 12 may be smaller than the opening 16A of the positive electrode film 16.

Electrodeposition may occur at the negative electrode film 12. By making the diameter A1 of the opening 12A of the negative electrode film 12 smaller than the diameter A2 of the opening 16A of the positive electrode film 16, the amount of the electrodeposition generated can be reduced.

The configuration of the other through-holes 102 to 105 is the same as the configuration of the through-hole 101. All of the through-holes 101 to 105 communicate with the outside of the battery module 2. For example, ambient air passes through each of the through-holes 101 to 105. Each of the electrode sheets 10 can be cooled by the air. Externally, a fan that sends air into each of the through-holes 101 to 105 may be installed. In addition, a refrigerant other than air, such as water, may pass through each of the through-holes 101 to 105, and externally, a pump that supplies the refrigerant to each of the through-holes 101 to 105 may be installed.

In addition, each of the through-holes 101 to 105 penetrates through the electrode sheets 10. By passing the refrigerant through each of the through-holes 101 to 105, it is possible to cool the electrode sheets 10 at the same time.

In addition, as the electrode sheet 10 is increased in size, the heat dissipation of the central region R1 is impeded as compared with the heat dissipation of the vicinity of the central region R1. Here, the large size is, for example, a size of 1 meter or more ×1 meter or more. When the heat dissipation of the central region R1 is impeded, the temperature of the central region R1 is higher than the temperature of the vicinity of the central region R1. With the configuration of the present embodiment, each of the through-holes 101 to 105 is located in the central region R1. By promoting the heat dissipation of the central region R1 by each of the through-holes 101 to 105, it is possible to reduce an increase in the temperature difference between the central region R1 and the vicinity of the central region R1.

The battery module 2 is mounted on a vehicle, such as a battery electric vehicle or a hybrid electric vehicle. Two or more battery modules 2 may be mounted on the vehicle. In this case, two or more battery modules 2 may be stacked and disposed. As a result, between the two adjacent battery modules 2, the through-holes 101 to 105 thereof can be coaxially disposed and communicate with each other. In one Modification, between two adjacent battery modules 2, the through-holes 101 to 105 thereof are not always needed to be disposed coaxially. In addition, in another Modification, two or more battery modules 2 may be stacked and disposed through a cooling plate (not shown). In this case, the through-holes 101 to 105 of each battery module 2 may communicate with a flow path of the refrigerant provided in the cooling plate.

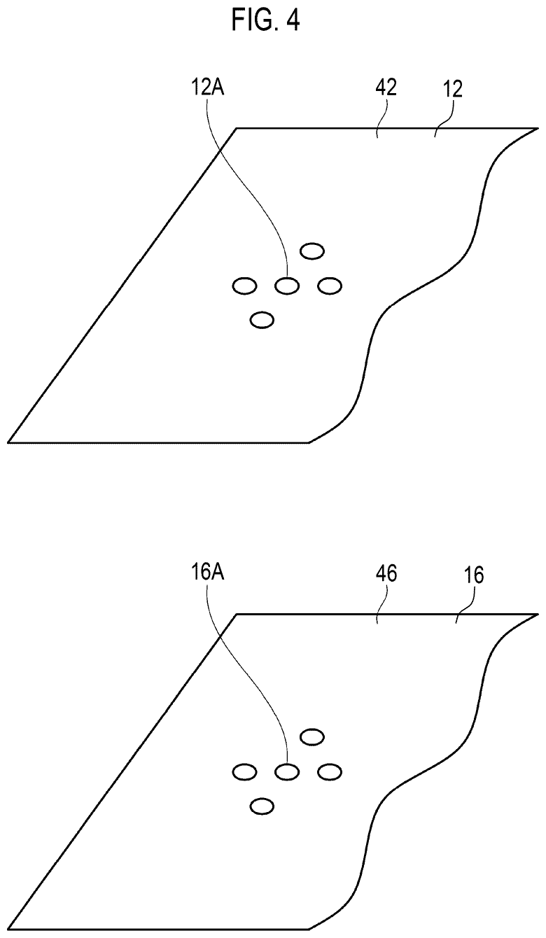

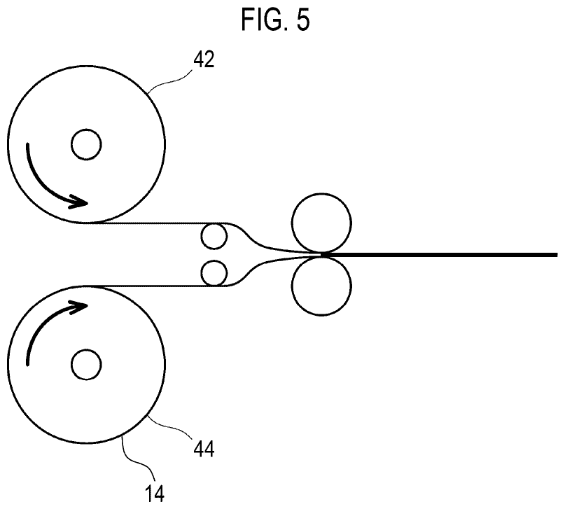

### Method of Manufacturing Battery Module 2 (see FIGS. 4 and 5)

A method of manufacturing the battery module 2 will be described with reference to FIGS. 4 and 5. In a first step, a negative electrode self-supporting film 42 containing a negative electrode active material and a positive electrode self-supporting film 46 containing a positive electrode active material are prepared. The negative electrode self-supporting film 42 is a member that serves as a base for the plurality of negative electrode films 12. The negative electrode film 12 is formed by cutting the negative electrode self-supporting film 42. In addition, the positive electrode self-supporting film 46 is a member that serves as a base for the plurality of positive electrode films 16. The positive electrode film 16 is formed by cutting the positive electrode self-supporting film 46. Here, the negative electrode self-supporting film 42 and the positive electrode self-supporting film 46 mean films that are supported by themselves without needing a support body, such as the current collector foil 14. The negative electrode self-supporting film 42 and the positive electrode self-supporting film 46 contain a binder for self-supporting. The binder may be a resin, such as cellulose, and may be fiberized by prior kneading.

In a second step, the opening 12A is formed in the negative electrode self-supporting film 42, and the opening 16A is formed in the positive electrode self-supporting film 46. Laser processing is used, for example, to form the openings 12A, 16A. The negative electrode self-supporting film 42 and the positive electrode self-supporting film 46 in which the openings 12A, 16A are provided are wound onto a roll for the next step.

FIG. 5 shows a third step. In the third step, first, a long foil 44 that is a member serving as a base for the plurality of current collector foils 14 is prepared. The long foil 44 is wound onto a roll. Next, the negative electrode self-supporting film 42 is joined to a first surface of the foil 44. As shown in FIG. 5, a roll-press method is used for joining. Further, the positive electrode self-supporting film 46 is also joined to a second surface of the foil 44 by the same press method as in FIG. 5. Here, the negative electrode self-supporting film 42 and the positive electrode self-supporting film 46 are joined to the foil 44 such that the opening 12A of the negative electrode self-supporting film 42 faces the opening 16A of the positive electrode self-supporting film 46 through the foil 44. As a result, the member serving as a base for the bipolar electrode sheet 10 is prepared. In addition, the members serving as the base for the unipolar positive electrode and negative electrode sheets 10 are also manufactured by the same press method as in FIG. 5.

In a fourth step, the member serving as a base for the electrode sheet 10 is cut to the size of each electrode sheet 10.

In a fifth step, the opening 14A is formed in the current collector foil 14 exposed in the opening 12A of the negative electrode film 12, that is, the negative electrode self-supporting film 42, in each of the electrode sheets 10. In the unipolar positive electrode sheet 10, the opening 14A is formed in the current collector foil 14 exposed in the opening 16A of the positive electrode film 16.

In a sixth step, the separator 20 in which the opening 20A is provided is prepared.

In a seventh step, the electrode sheets 10 and the separators 20 are alternately stacked such that the openings 12A, 14A, 16A, 20A are aligned in a row.

In an eighth step, the openings 14A of two adjacent current collector foils 14 are connected to each other by the adhesive layer 24. As a result, each of the through-holes 101 to 105 is defined.

In a ninth step, the electrolyte is injected between the electrode sheets 10, and the periphery of the electrode sheets 10 and the separators 20 is covered with the outer frame 30.

### Correspondence

The battery module 2 is an example of a “battery module”. The electrode sheets 10 and the separators 20 are examples of “a plurality of electrode sheets” and “a plurality of separators”, respectively. The through-holes 101 to 105 are examples of “through-holes”. The electrolyte 50 and the space S1 are examples of an “electrolyte” and a “space”, respectively. The negative electrode film 12, the current collector foil 14, and the positive electrode film 16 are examples of a “negative electrode film”, a “current collector foil”, and a “positive electrode film”, respectively. The openings 12A, 14A, 16A are examples of “openings”. The central region R1, the center C1, the outer edge E1, and the straight line L1 are examples of a “central region”, a “center”, an “outer edge”, and “any straight line”, respectively. The distances D1, D2 are examples of “distances”, and the point P1 is an example of a “point”. The negative electrode self-supporting film 42 and the positive electrode self-supporting film 46 are examples of a “negative electrode self-supporting film” and a “positive electrode self-supporting film”, respectively. The openings 12A, 16A, 14A are examples of a “first opening”, a “second opening”, and a “third opening”, respectively.

Hereinafter, points to consider regarding the technique shown in the embodiment will be described. The through-holes 101 and the like may be located on the periphery of the central region R1 instead of in the central region R1.

The number of the bipolar electrode sheet 10 may be at least one. The electrode sheets 10 may be constituted of, for example, one unipolar positive electrode sheet 10, one bipolar electrode sheet 10, and one unipolar negative electrode sheet 10.

In addition, the diameters A1 to A4 in FIG. 2 are merely examples of the diameters of the openings 12A to 20A. For example, the diameter of the opening 12A and the diameter of the opening 16A may be the same.

What is claimed is:

1. A battery module comprising:
a plurality of electrode sheets;
a plurality of separators alternately stacked with the electrode sheets; and
an electrolyte sealed between the electrode sheets, wherein:
a through-hole penetrating the electrode sheets and the separators is provided; and
the through-hole communicates with an outside and is isolated from a space in which the electrolyte is sealed.

2. The battery module according to claim 1, wherein the electrode sheets include at least one bipolar electrode sheet.

3. The battery module according to claim 2, wherein:
the bipolar electrode sheet includes
a current collector foil,
a negative electrode film provided on a first surface of the current collector foil, and
a positive electrode film provided on a second surface of the current collector foil;
an opening through which the through-hole passes is provided in each of the current collector foil, the positive electrode film, and the negative electrode film;
the opening in the negative electrode film and the opening in the positive electrode film are larger than the opening in the current collector foil; and
the opening in the negative electrode film is smaller than the opening in the positive electrode film.

4. The battery module according to claim 1, wherein:
the through-hole is located in a central region of the battery module when the battery module is viewed along a stacking direction of the electrode sheets; and
the central region is a set of points at which a distance to a center of the battery module is shorter than a distance to an outer edge of each of the electrode sheets on any straight line extending radially from the center toward the outer edge.

5. A method of manufacturing the battery module according to claim 3, the method comprising preparing the bipolar electrode sheet, wherein the preparing of the bipolar electrode sheet includes
forming a first opening in a negative electrode self-supporting film containing a negative electrode active material,
forming a second opening larger than the first opening in a positive electrode self-supporting film containing a positive electrode active material,
joining the negative electrode self-supporting film to the first surface of the current collector foil and joining the positive electrode self-supporting film to the second surface of the current collector foil such that the first opening in the negative electrode self-supporting film faces the second opening in the positive electrode self-supporting film through the current collector foil, and
forming a third opening smaller than the first opening in the current collector foil exposed in the first opening in the negative electrode self-supporting film.
